(19) United States
(12) Patent Application Publication
(10) Pub. No.: US 2025/0277527 A1
(43) Pub. Date: Sep. 4, 2025

(54) SNAP TOGETHER METAL SEAL GASKET

(71) Applicant: Hanon Systems, Daejeon (KR)

(72) Inventors: Eric Kesler, Northville, MI (US); Salvador Guadalajara, Juarez Chih. (MX); Daniel Ratkos, Warren, MI (US)

(21) Appl. No.: 18/592,146

(22) Filed: Feb. 29, 2024

(51) Int. Cl. F16J 15/06

(52) U.S. Cl. CPC F16J 15/06

(57) ABSTRACT

A seal assembly for an air conditioning system includes an annular inner seal member formed from a first material and an annular outer seal member coupled to the inner seal member by a snap-fit. The annular outer seal member has an inner surface, an outer surface, a first surface and a second surface opposing the first surface. The annular outer seal member is formed from a second material.

### FIELD OF THE INVENTION

The invention relates to a fitting for a vehicle air conditioning system and more particularly to a fitting for coupling tubing segments, the fitting including a seal having a first annular component formed from a first material received in a second annular component formed from a second material.

### BACKGROUND OF THE INVENTION

Automotive air conditioning system components typically include block fittings to couple pipes or tubing together to convey fluid therein. Due to environmental concerns, air conditioning efficiency, and legislation, it is desired to properly ensure leaking of the fluid is substantially minimized or prevented. Therefore, seals employed with the block fittings must be robust and essentially leak resistant. Additionally, various fluids are currently being investigated and employed with air conditioning systems for potentially improving the systems performance and cost efficiency. For example, fluids such as R290 (propane) with mineral oil and other oils and refrigerants are being examined for use in air conditioning systems.

Some current seals employed for such block fittings are formed from copper which has its advantages. However, copper is a very expensive material and the annealing process to soften copper is also expensive. Other seals employed include a rubber material over-molded to a metal washer which also result in increased costs.

Therefore, there is a desire for a seal that minimizes operation processes and materials that increase costs and manufacturing time while still remaining compatible and resilient for use with current and potential future fluids.

### SUMMARY OF THE INVENTION

In accordance and attuned with the instant disclosure, an elastomeric seal that minimizes damage caused to the elastomeric seals during decompression of the air conditioning system while maintaining required sealing function, has surprisingly been discovered.

According to an embodiment of the disclosure, a seal assembly for an air conditioning system includes an annular inner seal member formed from a first material and an annular outer seal member coupled to the inner seal member by a snap-fit. The annular outer seal member has an inner surface, an outer surface, a first surface and a second surface opposing the first surface. The annular outer seal member is formed from a second material.

According to another embodiment of the disclosure, a seal assembly for an air conditioning system is disclosed. The seal assembly includes an annular inner seal member formed from a first material. The seal assembly further includes an annular outer seal member coupled to the inner seal member. The annular outer seal member has an inner surface, an outer surface, a first surface and a second surface opposing the first surface. The inner surface includes a plurality of first seal retaining sections are interposed between a plurality of second seal retaining sections cooperating with each other to snap-fit the annular inner seal member to the annular outer seal member.

### DRAWINGS

The above, as well as other advantages of the present invention, will become readily apparent to those skilled in the art from the following detailed description of a preferred embodiment when considered in the light of the accompanying drawings in which:

FIG. 1 is an top perspective view of a block fitting assembly according to an embodiment of the instant disclosure;

FIG. 2 is a partially exploded top perspective view of the block fitting assembly of FIG. 1;

FIG. 3 is a cross-section view of the block fitting assembly of FIGS. 1-2, taken through line 3-3 of FIG. 1;

FIG. 4 is a top perspective view of a seal assembly of the block fitting of FIGS. 1-3;

FIG. 5 is an exploded top perspective view of the seal assembly of FIG. 4;

FIG. 6 is a cross-sectional view of the seal assembly of FIGS. 4-5, taken through line 6-6;

FIG. 7 is an enlarged fragmentary cross-sectional view of a seal assembly of the block fitting assembly of FIGS. 1-3 according to another embodiment of the disclosure; and

FIG. 8 is an enlarged fragmentary cross-sectional view of a seal assembly of the block fitting assembly of FIGS. 1-3 according to another embodiment of the disclosure.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the order of the steps presented is exemplary in nature, and thus, is not necessary or critical.

“A” and “an” as used herein indicate “at least one” of the item is present; a plurality of such items may be present, when possible. As used herein, “substantially” means “to a considerable degree,” “largely,” or “proximately” as a person skilled in the art in view of the instant disclosure would understand the term. Spatially relative terms, such as “front,” “back,” “inner,” “outer,” “bottom,” “top,” “horizontal,” “vertical,” “upper,” “lower,” “side,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

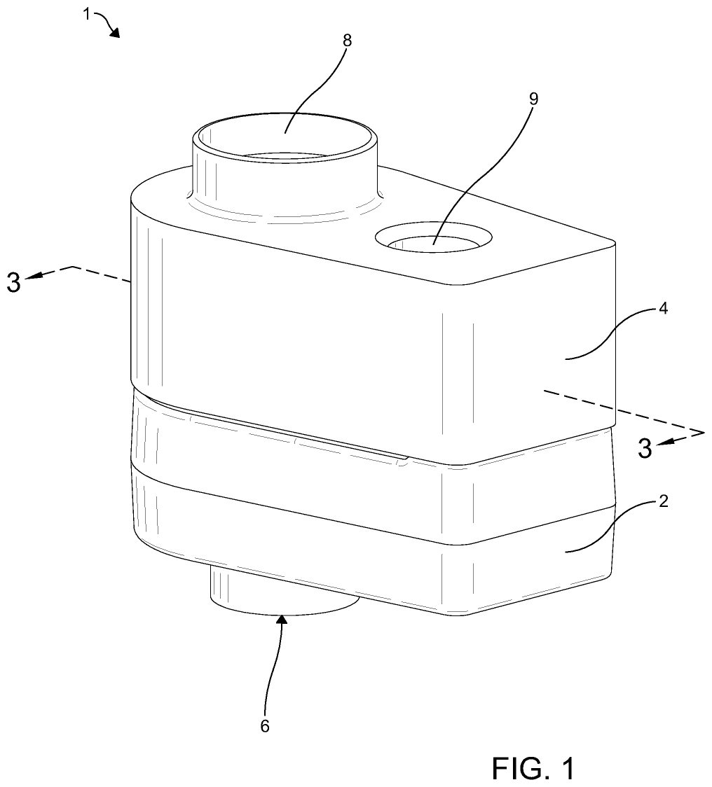

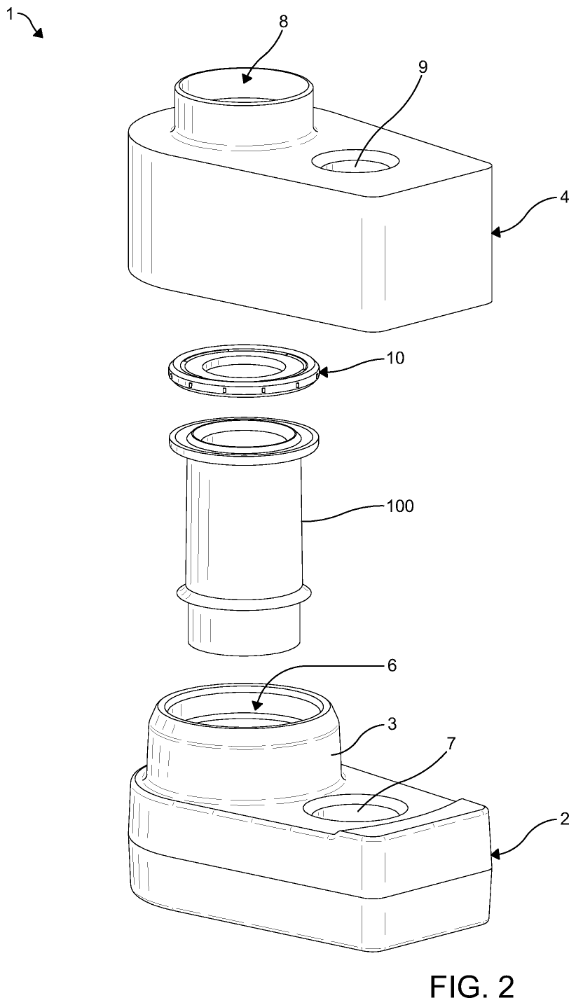

FIGS. 1-3 illustrate a block fitting assembly 1 according to an embodiment of the invention. The block fitting assembly 1 is configured for a fluid system of a vehicle such as a R134a, 1234yf, R744, R290, or R152a refrigerant system of a vehicle, for example. However, it is understood, the block fitting assembly 1 of the present disclosure can be configured for other systems such as oil and gas drilling systems, refrigerant systems other than vehicle refrigerant systems, or other fluid systems, as desired. The assembly 1 is configured to receive an end of a first tube 100 and an end of a second tube (not shown) therein to substantially axially align the tubes 100 to each other. While only one tube is shown, the tubes will herein be referred to as “tubes 100.” The assembly 1 includes a male block fitting 2 and a female block fitting 4. First apertures 6, 8 of the male block fitting 2 and the female block fitting 4, respectively, receive an end of one of the tubes 100 respectively therein to substantially axially align the tubes 100.

A seal assembly 10 is received between the male block fitting 2 and the female block 4 fitting to substantially surround and seal the first apertures 6, 8 of the male block fitting 2 and the female block fitting 4. A female indentation 5 is formed in the female block fitting 4 to receive a male protuberance 3 formed on the male block fitting 2 to facilitate alignment of the respective first apertures 6, 8. Thus, a fluid is conveyed through the tubes 100 in a substantially leak free manner. Second apertures 7, 9 formed in the male block fitting 2 and the female block fitting 4, respectively, receive a fastener (not shown) therein to facilitate fastening the male block fitting 2 and the female block fitting 4 together. It is understood features and shapes of the block fittings 2, 4 shown in FIGS. 1-3 can vary depending on the application or the type of block fitting assembly employed. For example, the male block fitting 2 and/or the female block fitting 4 can include one or more holes for receiving aligning pins. In another example, each of the male block fitting 2 and the female block fitting 4 can have alternate cross-sectional shapes, different from the pear shape or obovate shape shown, such as rectangular. peanut shaped, round, ovular, oblong, polygonal, or any other shape as desired.

As illustrated, the block fittings 2, 4 are illustrated as a block fitting separate from a component or system. However, according to an alternate embodiment, the block fittings 2, 4 can each be configured as a component such as a component block integrated with a system or integrated with a system structure. For example, the component can be a refrigerant system component such as a condenser block or compressor manifold. In other examples, the component can be a housing or other similar structure of a system. According to the alternate embodiment, the male block fitting 2 is a block fitting configured for coupling to the female block components configured as a female block component of a system or a system structure. Similarly, the male block component can be a male block component of a system or a system structure configured for coupling to the female block fitting 4 configured as a block fitting.

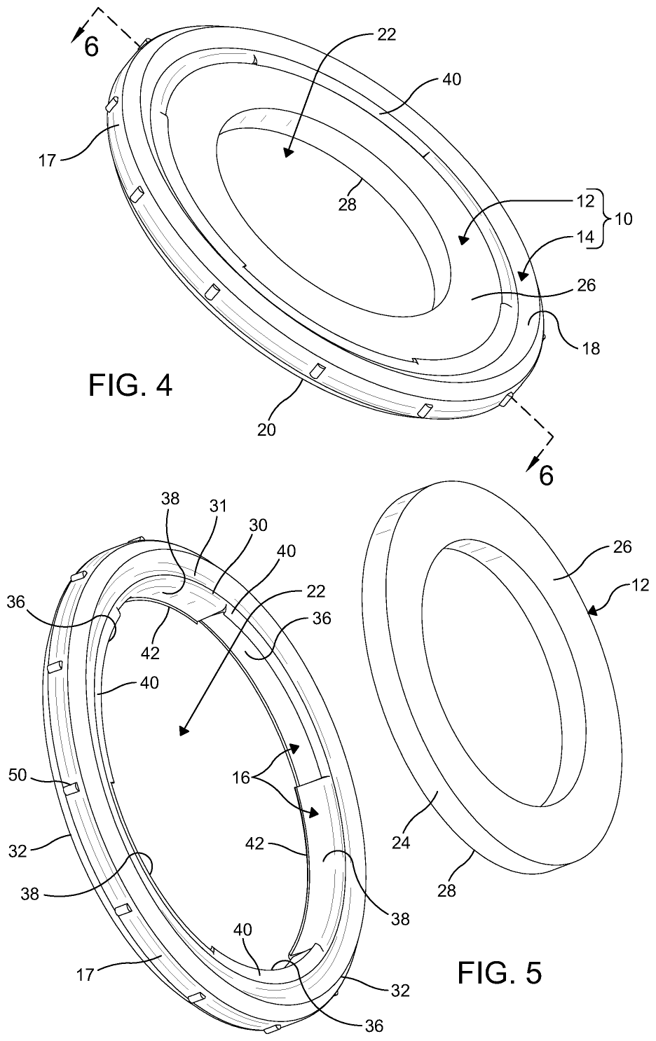

FIGS. 4-6 illustrate the seal assembly 10 of the block fitting assembly 1. The seal assembly 10 includes an annular inner seal member 12 and an annular outer seal member 14 coupled to the inner seal member 12. The inner seal member 12 is formed from a metal material. In an example, the inner seal member 12 is formed from a deformable material such as aluminum alloy 1100, 3000, 5000, 6000, or 7000. In another example, the inner seal member 12 can be a copper alloy C36000 because it has a desirable hardness or softness. However, the inner seal member 12 may be formed from other materials, if desired. For example, a material with a hardness in the range of about 10-60 HR on the Rockwell HR-15T hardness scale so the inner seal member 12 can locally and desireably deform between the block fittings 12, 14. In an embodiment, the inner seal member 12 can have a thickness of 1 mm and it would be desireable for the block fittings 2, 4 to penetrate the inner seal member 12 at a distance of about between 0.025 mm and 0.50 mm. Where the inner seal member 12 has other thickness, the desired penetration of the block fittings 2, 4 would a percentage of the thickness of the inner seal member 12 of between about 2.5% and 50%. The inner seal member 12 is formed by a stamping process or other machined process. In an embodiment of the disclosure, the inner seal member 12 can be electroplated or covered, by electrolysis, with a coating, such as tin. The electroplated tin is advantageous in providing a “dry” lubrication during assembly. The tin can have a thickness of between about 0 and 0.15 mm. For example, the tin electroplate facilitates the inner seal member 12 in embedding and mating with the block fitting assembly 1 during assembly due to creep properties of tin. The creep of the tin advantageously fills or perfects imperfections in both the mating surfaces of the block fitting assembly 1 and an outer surface of the inner seal member 12.

The outer seal member 14 is formed from a nylon such as nylon 6/6 or an elastomeric material such as thermoplastic elastomer (TPE), thermoplastic vulcanizate (TPV), thermoplastic polyurethane (TPU), thermoplastic rubber (TPR) or similar. Materials that have been found to be favorable for the outer seal member 14 that can easily be manufactured in processes involving injection molding, stamping, and dispensing. However, it is understood the outer seal member 14 may be formed from other materials having desired characteristics such as deformability, softness, and chemical resistance.

In the embodiment illustrated, the outer seal member 14 is coupled to the inner seal member 12 by a snap-fit, wherein a portion of the inner seal member 12 snaps to an inner portion of the outer seal member 14, which will be described in further detail hereinbelow. For example, as shown, the outer seal member 14 is coupled to the inner seal member 12 about an outer circumferential surface 24, an outer radial portion of a first surface 26, and an outer radial portion of a second surface 28 opposite the first surface 26 of the inner seal member 12. As a result, the inner seal member 12 impregnates the outer seal member 14 to form the assembled seal assembly 10.

The first surface 26 and the second surface 28 of the inner seal member 12 are substantially planar. The outer seal member 14 includes a first surface 18 and an opposing second surface 20, an annular inner surface 16 and an outer circumferential surface 17. The inner surface 16 defines an aperture 22 through the outer seal member 14. In the embodiment illustrated, the first surface 18 and the second surface 20 each have an annular first protuberance 30 and an annular second protuberance 32 extending outwardly therefrom. The first protuberance 30 is disposed on an innermost portion of each of the first surface 18 and the second surface 20 of the outer seal member 14. The second protuberance 32 is annularly disposed adjacent the outer surface 17. An annular recess 31 is formed intermediate the protuberances 30, 32 on each of the first surface 18 and the second surface 20 of the outer member 14.

In the embodiment illustrated, the recess 31 has an arcuate cross-sectional profile. Although, it is understood the cross-sectional profile of the recess 31 can have any shape as desired. The first protuberance 30 has a substantially planar cross-sectional profile, although it is understood other cross-sectional profiles can be contemplated. The second protuberance 32 has a substantially triangular cross-sectional profile. Although, other cross-sectional profiles can be employed such as a polygonal cross-sectional profile, an arcuate or undulating cross-sectional profile, or any other shape as desired. As shown, the second protuberance 32 is continuous on both the first surface 18 and the second surface 20 of the outer seal member 14. However, in other embodiments the second protuberance 32 can be formed at non-continuous intervals along a circular path or alternate path on one or both of the first surface 18 and the second surface 20 of the outer seal member 14. As shown, the second protuberance 32 interfaces with an edge 34 of the outer surface 17 of the outer seal member 14. However, the second protuberance 32 can be spaced inwardly from the edge 34.

The inner surface 16 of the outer seal member 14 is divided into first seal retaining sections 36 interposed between second seal retaining sections 38. The first sections 36 and the second sections 38 are the same but opposite in configuration with respect to a plane parallel to the first surface 18 and the second surface 20. The sections 36, 38 are disposed and extend at about 60 degree arc length intervals with respect to the annular inner surface 16 of the outer seal member 14, wherein each of the first sections 36 are spaced from each other at 60 degree arc length intervals and each of the second sections are spaced from each other at 60 degree arc lengths from each other. Therefore, in the embodiment illustrated, there are three first sections 36 and three second sections 38. However, any number of the first sections 36 and the second sections 38 can be included as desired. For example, there can be six of the first sections 36 and six of the second sections 38 disposed and extending at 30 degree arc length intervals. In an other example, there can be two first sections 36 and two second sections 38 disposed at and extending at 45 degree arc length intervals. In yet another example, there can be any number of first sections 36 and second sections 38 as desired such as more than six and fewer than two of each or any division of the sections that are even intervals of 360 degrees. The first sections 36 and the second sections 38 extend at arc lengths that are equal to each other. However, it is understood, the first sections 36 and the second sections 38 can have varying arc lengths or or can be positioned at uneven intervals.

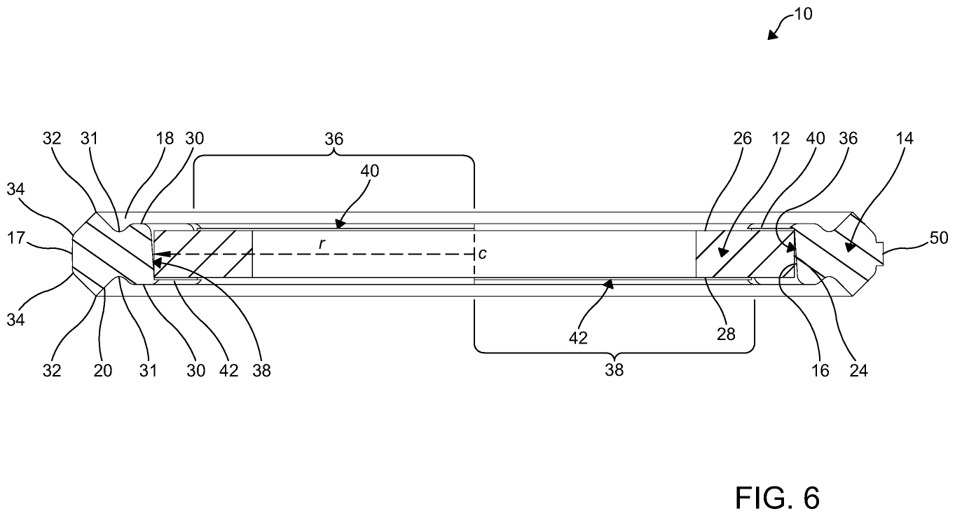

As shown in FIG. 6, the inner surface 16 of the first sections 36 are inclined, wherein a radial distance r (i.e. radius), with respect to a circumferential center of the inner surface 16 decreases from the second surface 20 to the first surface 18 of the outer seal member 14 at a substantially constant rate. The inner surface 16 of the second sections 38 are inclined at an equal and opposite direction of the inner surface 16 of the first sections 36, wherein the radial distance r (i.e. radius), with respect to a circumferential center of the inner surface 16 increases from the second surface 20 to the first surface 18 of the outer seal member 14 at a substantially constant rate. It is understood, the radial distance r of each of the inner surface 16 of each of the first sections 36 and second sections 38 can increase or decrease at varying rates or the radial distance r of the inner surface 16 in a direction from the first surface 18 to the second surface 20 can remain constant, if desired.

Each of the first sections 36 include a first lip 40 continuous with the first surface 18 of the outer seal member 14 and extending inwardly, with respect to the outer seal member 14, at a distance from the inner surface 16 of the outer seal member 14. The first lip 40 extends at a distance from the inner surface 16 to engage a portion of the first surface 26 of the inner seal member 12. Each of the second sections 38 include a second lip 42 continuous with the second surface 20 of the outer seal member 14 and extending inwardly, with respect to the outer seal member 14, at a distance from the inner surface 16 of the outer seal member 14. The second lip 42 extends at a distance to engage a portion of the second surface 28 of the inner seal member 12. While the lips 40, 42 extend continuously with the respective surfaces 18, 20 of the outer seal member 14, it is understood the lips 40, 42 can extend inwardly from the inner surface 16 but spaced at a distance from the respective surfaces 26, 28.

The outer surface 17 of the outer seal member 14 includes a plurality of ribs 50 extending outwardly from the outer surface 17. The ribs 50 are elongate and are arranged in a direction substantially perpendicular to the first surface 18 and the second surface 20 of the outer seal member 14. The ribs 50 are substantially centered on the outer surface 17 with respect to the first surface 18 and the second surface 20. The ribs 50 are spaced equally from each other along the entire circumference of the outer surface 17. However, it is understood the ribs 50 can be any quantity and can have alternate shapes, arrangements, and placement.

For assembly, the inner seal member 12 is received in the outer seal member 14. Particularly, the inner seal member 12 is received in the retaining sections 36, 38 of the outer seal member 14 by a snap-fit coupling. The inner seal member 12 can be received through the aperture 22 in a direction from the first surface 18 or the second surface 20. When received in the outer seal member 14, the outer surface 24 of the inner seal member 12 engages the inner surface 16 of the outer seal member 14. The opposing inclines of the inner surface 16 of the outer seal member 14 at the sections 36, 38 act as counteracting forces to maintain and align the inner seal member 12 in planar alignment with the outer seal member 14. The lips 40 of the first retaining sections 36 are configured as a stop and counteract with opposing forces of the lips 42 of the second retaining sections 38 to maintain, stabilize, support, and desireably align the inner seal member 12 within the outer seal member 14. The arcuate spacing and alternating of the first retaining sections 36 with the second retaining sections 38, permits both easy insertion and stabilization of the inner seal member 12 within the outer seal member 14.

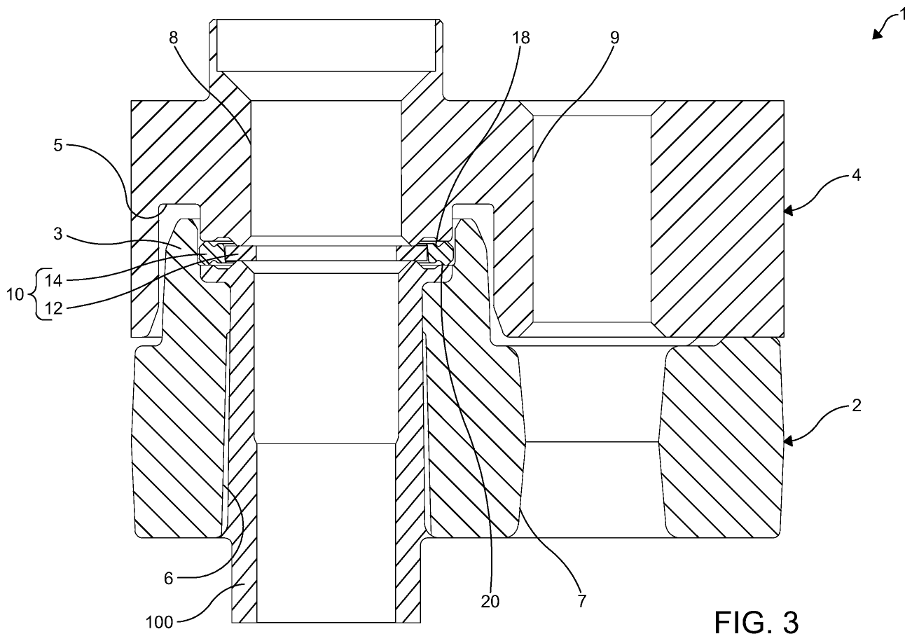

With renewed reference to FIG. 3, advantageously, the seal assembly 10 provides a robust sealing effect that minimizes leaking of gases through the block fitting assembly 1. The second protuberance 32 effectively engage both the male block fitting 2 and female block fitting 4 mating surfaces to provide efficient sealing therebetween and the engagement permits the outer seal member 14 to desireably deform within a gap between the block fittings 2, 4 without forcing the fittings 2, 4 to be spaced from each other at a distance that is undesireable. The advantages of the seal assembly 10 include, simplification of the manufacturing process and reduced manufacturing cycle time, less expensive material, reduced tooling complexity, elimination of certain processes such as annealing operations due to correct hardness of materials, eliminations of a bonding agent of a metal to a rubber according to known seal assemblies, compatibility with a wide range of refrigerants, oils, and other fluids, ability to employ materials of the seal assembly 10 that have optimal material properties for efficient sealing material, and minimized cost.

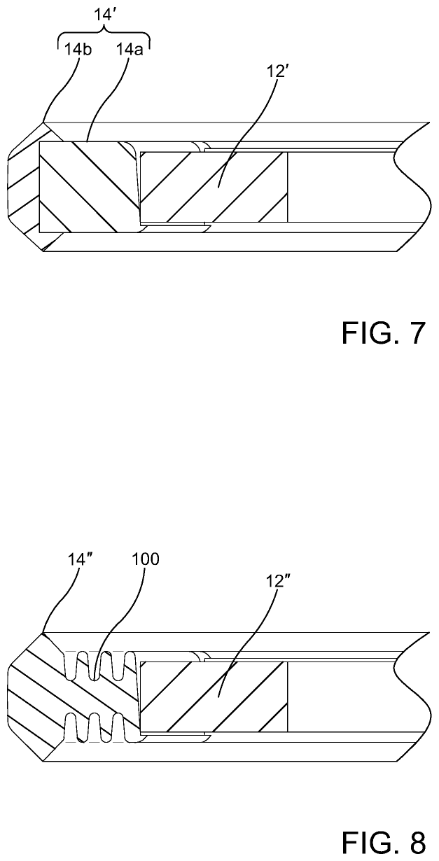

As shown in FIG. 7, a seal assembly 10′ according to another alternate embodiment is illustrated. Features of the seal assembly 10′ of FIG. 7 the same as or similar to the features of the seal assembly 10 of FIGS. 1-6 are indicated by the same reference numeral but with a prime (′) symbol for convenience. The seal assembly 10′ is substantially the same as the seal assembly 10 of FIGS. 1-6, except the seal assembly 10′ is formed from three components instead of two components. The outer seal member 14′ includes a first portion 14a thereof that is formed from a first material such as nylon and second portion 14b thereof that is formed from a TPE, TPV, or other material with similar softness properties. The second portion 14b is overmolded to the first portion 14a. It is understood, the seal assemblies 10, 10′ can include outer seal members 14, 14′ that are formed from more than two components of differing materials or combination of materials as desired to achieve desireable sealing.

As shown in FIG. 8, a seal assembly 10″ according to another alternate embodiment is illustrated. Features of the seal assembly 10″ of FIG. 7 the same as or similar to the features of the seal assembly 10, 10′ of FIGS. 1-7 are indicated by the same reference numeral but with a double prime (″) symbol for convenience. The seal assembly 10″ is substantially the same as the seal assembly 10 of FIGS. 1-6, except the outer seal member 14″ of the seal assembly 10″ includes a plurality of serrations 100 formed in the first surface 18″ and the second surface 20″ thereof. In one example, each of the serrations 100 can be continuously formed in a concentrically formed arrangement with respect to each other in each of the surfaces 12′, 14′. In another example, the serrations 100 can be intermittently, randomly or in a pattern, formed in the surfaces 18″, 20″ or configured as arcuate, circular, ovular, or any other shaped holes formed in the surfaces 18″, 20″. The serrations 100 improve sealing during compression and decompression of the fluids flowing through the block fitting assembly because the serrations 100 permit the outer seal member 14″ to contract and expand since the serrations 100 cause space for the outer seal member 14″ to move in a contraction and expansion configuration. The serrations 100 also facilitate quick removal of fluid gases from the area about the seal assembly 10″.

While certain representative embodiments and details have been shown for purposes of illustrating the invention, it will be apparent to those skilled in the art that various changes may be made without departing from the scope of the disclosure, which is further described in the following appended claims.

What is claimed is:

1. A seal assembly for an air conditioning system comprising:
an annular inner seal member formed from a first material; and
an annular outer seal member coupled to the inner seal member by a snap-fit, the annular outer seal member having an inner surface, an outer surface, a first surface and a second surface opposing the first surface, the annular outer seal member formed from a second material.

2. The seal assembly of claim 1, wherein the first material is a metal.

3. The seal assembly of claim 2, wherein the first material is an aluminum alloy.

4. The seal assembly of claim 2, wherein the first material is a copper alloy.

5. The seal assembly of claim 2, wherein the second material is a nylon.

6. The seal assembly of claim 2, wherein the second material is one of a thermoplastic elastomer, a thermoplastic vulcanizate, a thermoplastic polyurethane, and a thermoplastic rubber.

7. The seal assembly of claim 2, wherein the annular inner seal member is coated with tin.

8. The seal assembly of claim 1, wherein the annular outer seal member includes a plurality of first seal retaining sections interposed between a plurality of second seal retaining sections each receiving an outer surface of the annular inner seal member, each of the plurality of first seal retaining sections and the plurality of second retaining sections is formed at the inner surface of the annular outer seal member.

9. The seal assembly of claim 8, wherein each of the plurality of first seal retaining sections and each of the plurality of second seal retaining sections extend at a range between about 0 and 180 degree intervals with respect to the inner surface of the annular outer seal member.

10. The seal assembly of claim 9, wherein each of the plurality of first seal retaining sections and each of the plurality of second seal retaining sections extend at one of 30 degree intervals, 45 degree intervals, and 60 degree intervals.

11. The seal assembly of claim 8, wherein each of the first seal retaining sections include a first lip extending inwardly from the inner surface of the annular outer seal member adjacent the first surface of the annular outer seal member, and wherein each of the second seal retaining sections include a second lip extending inwardly from the inner surface of the annular outer seal member adjacent the second surface of the annular outer seal member.

12. The seal assembly of claim 8, wherein the inner surface of each of the first seal retaining sections is inclined in a first direction and the inner surface of each of the second seal retaining sections is inclined in a second direction, wherein the first direction is substantially equal but opposite from the second direction.

13. The seal assembly of claim 1, wherein the annular outer seal member has a first protuberance formed on at least one of the first surface and the second surface thereof.

14. The seal assembly of claim 13, wherein the annular outer seal member has a second protuberance formed on the at least one of the first surface and the second surface thereof.

15. The seal assembly of claim 1, wherein a plurality of ribs are formed on the outer surface of the annular outer seal member.

16. The seal assembly of claim 1, wherein the annular outer seal member has a plurality of serrations formed in at least one of the first surface and the second surface.

17. The seal assembly of claim 1, wherein the outer seal member is formed from a pair of components coupled to each other, wherein a first one of the pair of components is a nylon and a second one of the pair of components is a thermoplastic.

18. A seal assembly for an air conditioning system comprising:
an annular inner seal member formed from a first material; and
an annular outer seal member coupled to the inner seal member, the annular outer seal member having an inner surface, an outer surface, a first surface and a second surface opposing the first surface, wherein the inner surface includes a plurality of first seal retaining sections are interposed between a plurality of second seal retaining sections cooperating with each other to snap-fit the annular inner seal member to the annular outer seal member.

19. The seal assembly of claim 18, wherein the annular outer seal member is formed from a second material and each of the first seal retaining sections and the second seal retaining sections include a lip extending inwardly from the inner surface of the annular outer seal member.

20. The seal assembly of claim 18, wherein the inner surface of each of the first seal retaining sections is inclined in a first direction and the inner surface of the second seal retaining sections is inclined in an equal but opposite second direction from the first direction.
